(19) United States
(12) Patent Application Publication
(10) Pub. No.: US 2013/0069846 A1
(43) Pub. Date: Mar. 21, 2013

(54) ANTENNA STRUCTURE FOR REDUCING THE SAR VALUE

(71) Applicant: CHUN-CHUAN CHANG, KEELUNG CITY (TW)

(72) Inventor: CHUN-CHUAN CHANG, KEELUNG CITY (TW)

(73) Assignee: AUDEN TECHNO CORP., TAOYUAN COUNTY (TW)

(21) Appl. No.: 13/238,232

(22) Filed: Sep. 21, 2011

(51) Int. Cl. H01Q 1/42

(52) U.S. Cl. 343/872

(57) ABSTRACT

An antenna structure disposed inside an external casing according to an optimum separation distance for reducing the SAR value includes a substrate unit and an antenna unit. The substrate unit includes at least one substrate body. The antenna unit includes at least one antenna layer disposed on the substrate body. The antenna layer is extended along an X-axis direction to form an X-axis distance and is extended along a Y-axis direction to form a Y-axis distance, the X-axis direction is vertical to the Y-axis direction, and the X-axis distance of the antenna layer is larger than the Y-axis distance of the antenna layer. In addition, the optimum separation distance is defined from one end of the antenna layer to the external surface of the external casing along the X-axis direction, and the optimum separation distance is substantially between 5 mm and 20 mm.

### BACKGROUND OF THE INVENTION

1. Field of the Invention

The instant disclosure relates to an antenna structure, and more particularly, to an antenna structure disposed inside an external casing according to an optimum separation distance for reducing the SAR value.

2. Description of Related Art

In a wireless communication system, such as a notebook computer or a tablet computer, an antenna is a component for transmitting and receiving electromagnetic waves. The way that an antenna is designed and the location that it is mounted in the system influences its radiation pattern, and the quality of signal transmission. Furthermore, how the antenna is configured in the system will have a great effect on the cost of manufacturing the whole system. However, although the Federal Communication Committee (FCC) of USA prescribes that the permissible electromagnetic wave absorption rate (Specific Absorption Rate, SAR) shall not exceed 1.6 mW/g according to the four test sites (top, bottom, left, and right sides) close to the user of the notebook computer or the tablet computer, the SAR cannot be reduced effectively to less than 1.6 mW/g due to the limited space inside the notebook computer or the tablet computer.

### SUMMARY OF THE INVENTION

One aspect of the instant disclosure relates to an antenna structure disposed inside an external casing according to an optimum separation distance for reducing the SAR value

One of the embodiments of the instant disclosure provides an antenna structure disposed inside an external casing according to an optimum separation distance for reducing the SAR value, comprising: a substrate unit and an antenna unit. The substrate unit includes at least one substrate body. The antenna unit includes at least one antenna layer disposed on the at least one substrate body, wherein the at least one antenna layer is extended along an X-axis direction to form an X-axis distance and is extended along a Y-axis direction to form a Y-axis distance, the X-axis direction is vertical to the Y-axis direction, and the X-axis distance of the at least one antenna layer is larger than the Y-axis distance of the at least one antenna layer. In addition, the optimum separation distance is defined from one end of the at least one antenna layer to the external surface of the external casing along the X-axis direction, and the optimum separation distance is substantially between 5 mm and 20 mm.

Another one of the embodiments of the instant disclosure provides an antenna structure disposed inside an external casing according to an optimum separation distance for reducing the SAR value, comprising: a substrate unit and an antenna unit. The substrate unit includes at least one substrate body. The antenna unit including at least one antenna layer disposed on the at least one substrate body, wherein the at least one antenna layer is extended along an X-axis direction to form an X-axis distance and is extended along a Y-axis direction to form a Y-axis distance, the X-axis direction is vertical to the Y-axis direction, and the X-axis distance of the at least one antenna layer is smaller than the Y-axis distance of the at least one antenna layer. In addition, the optimum separation distance is defined from one end of the at least one antenna layer to the external surface of the external casing along the Y-axis direction, and the optimum separation distance is substantially between 5 mm and 20 mm.

Therefore, the optimum separation distance defined from one end of the at least one antenna layer to the external surface of the external casing along the X-axis direction is substantially between 5 mm and 20 mm, and the optimum separation distance defined from one end of the at least one antenna layer to the external surface of the external casing along the Y-axis direction is substantially between 5 mm and 20 mm, thus the instant disclosure can obtain the SAR value less than 1.6 mW/g in high or low frequency operation according to the test site close to the external casing for testing the SAR value of the antenna structure.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a plane, schematic view of one external casing of the instant disclosure;

FIG. 2 shows a plane, schematic view of the antenna structure disposed inside the external casing according to the first embodiment of the instant disclosure;

FIG. 3 shows a plane, schematic view of the antenna structure disposed inside the external casing according to the second embodiment of the instant disclosure;

FIG. 4 shows a plane, schematic view of the antenna structure disposed inside the external casing according to the third embodiment of the instant disclosure;

FIG. 5 shows a plane, schematic view of the antenna structure disposed inside the external casing according to the fourth embodiment of the instant disclosure;

FIG. 6 shows a plane, schematic view of another external casing of the instant disclosure;

FIG. 7 shows a plane, schematic view of the antenna structure disposed inside the external casing according to the fifth embodiment of the instant disclosure;

FIG. 8 shows a plane, schematic view of the antenna structure disposed inside the external casing according to the sixth embodiment of the instant disclosure;

FIG. 9 shows a plane, schematic view of the antenna structure disposed inside the external casing according to the seventh embodiment of the instant disclosure;

FIG. 10 shows a plane, schematic view of the antenna structure disposed inside the external casing according to the eighth embodiment of the instant disclosure; and

FIG. 11 shows a plane, schematic view of another antenna structure of the instant disclosure.

### DETAILED DESCRIPTION OF THE PREFERRED EMBODIMENTS

### First Embodiment

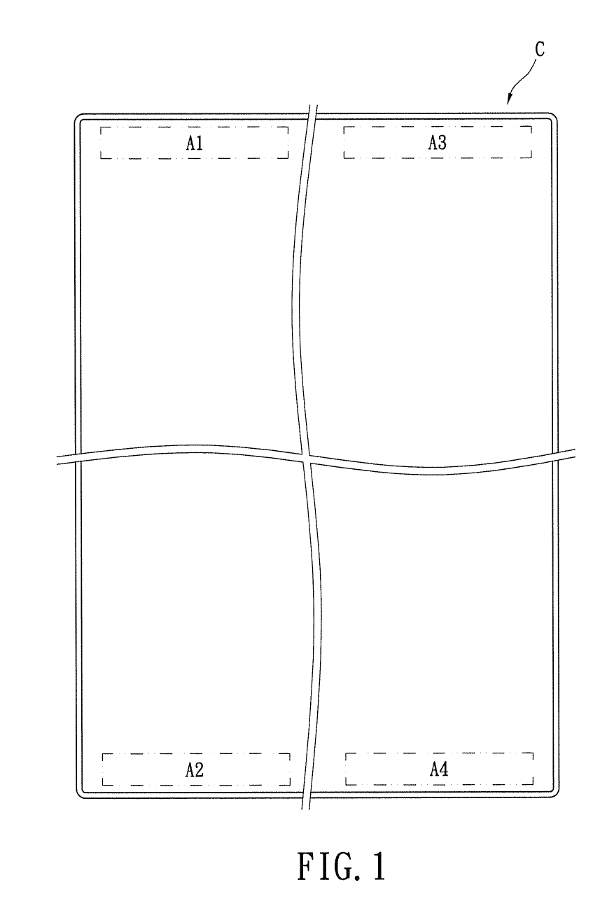

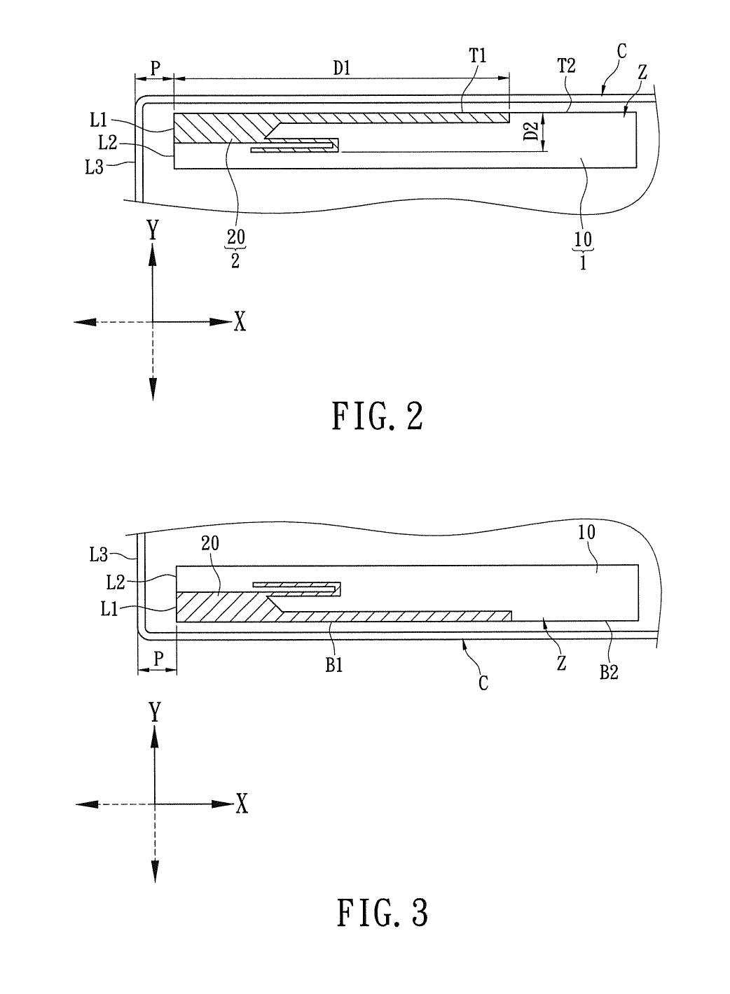

Referring to FIGS. 1 and 2, where the first embodiment of the instance disclosure provides an antenna structure Z disposed inside an external casing C (such as the casing of any electronic device) according to an optimum separation distance P for reducing the SAR value, and the antenna structure Z comprises a substrate unit 1 and an antenna unit 2. For example, the external casing C has a plurality of corner areas (A1, A2, A3 and A4 shown as the four phantom-line areas in FIG. 1) disposed in the external casing C and adjacent to the external surface of the external casing C, and the antenna structure Z can be disposed on one of the corner areas (A1, A2, A3 and A4) of the external casing C. For example, the antenna structure Z is disposed on the corner area A1 of the external casing C.

Referring to FIG. 2, the substrate unit 1 includes at least one substrate body 10. For example, the substrate body 10 may be a microwave substrate. However, the microwave substrate is merely an example and is not meant to limit the instant disclosure. Moreover, the antenna unit 2 includes at least one antenna layer 20 disposed on the substrate body 10, and the antenna layer 20 has at least one signal feeding point (no label in drawings) and at least one grounding point (no label in drawings). For example, the antenna layer 20 may be a PIFA (Plane Inverted-F Antenna). However, the PIFA is merely an example and is not meant to limit the instant disclosure.

Referring FIG. 2, the antenna layer 20 can be extended along an X-axis direction (the positive or the negative X-axis direction of the XY axis coordinate as shown in FIG. 2) to form an X-axis distance D1 and be extended along a Y-axis direction (the positive or the negative Y-axis direction of the XY axis coordinate as shown in FIG. 2) to form a Y-axis distance D2. The X-axis direction is vertical to the Y-axis direction, and the X-axis distance D1 of the antenna layer 20 is larger than the Y-axis distance D2 of the antenna layer 20. In addition, the optimum separation distance P can be defined from one end of the antenna layer 20 to the external surface of the external casing C along the X-axis direction, and the optimum separation distance P may be substantially between 5 mm and 20 mm. For example, when the optimum separation distance P is substantially between 5 mm and 20 mm from one end of the antenna layer 20 to the external surface of the external casing C along the X-axis direction as shown in FIG. 2, and the test site for testing the SAR value of the antenna structure Z as shown in FIG. 2 is close to the topmost side of the external casing C along the Y-axis direction and the topmost side T1 of the antenna layer 20 along the Y-axis direction, the instant disclosure can obtain the SAR value less than 1.6 mW/g in high or low frequency operation according to the test site for testing the SAR value.

For example, referring to FIG. 2, the optimum separation distance P can be defined from the leftmost side L1 of the antenna layer 20 along the X-axis direction to the leftmost side L3 of the external casing C along the X-axis direction. In addition, the leftmost side L1 of the antenna layer 20 along the X-axis direction can be substantially flushed with the leftmost side L2 of the substrate body 10 along the X-axis direction, and the topmost side T1 of the antenna layer 20 along the Y-axis direction can be substantially flushed with the topmost side T2 of the substrate body 10 along the Y-axis direction.

### Second Embodiment

Referring to FIGS. 1 and 3, where the second embodiment of the instance disclosure provides an antenna structure Z using an optimum separation distance P for reducing the SAR value. Comparing FIG. 3 with FIG. 2, the difference between the second embodiment and the first embodiment is that: the antenna structure Z of the second embodiment can be disposed on one corner area A2 of the external casing C. Moreover, the leftmost side L1 of the antenna layer 20 along the X-axis direction can be substantially flushed with the leftmost side L2 of the substrate body 10 along the X-axis direction, and the bottommost side B1 of the antenna layer 20 along the Y-axis direction can be substantially flushed with the bottommost side B2 of the substrate body 10 along the Y-axis direction. Of course, the optimum separation distance P also can be defined from the leftmost side L1 of the antenna layer 20 along the X-axis direction to the leftmost side L3 of the external casing C along the X-axis direction.

### Third Embodiment

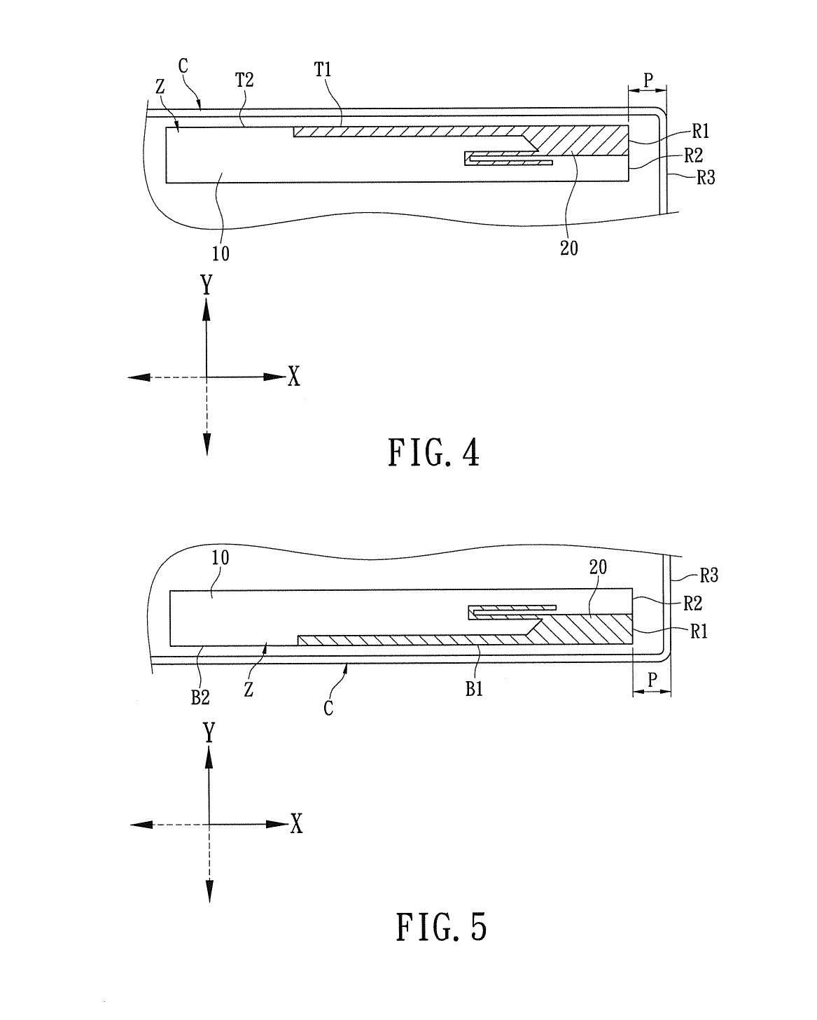

Referring to FIGS. 1 and 4, where the third embodiment of the instance disclosure provides an antenna structure Z using an optimum separation distance P for reducing the SAR value. Comparing FIG. 4 with FIG. 2, the difference between the third embodiment and the first embodiment is that: the antenna structure Z of the second embodiment can be disposed on one corner area A3 of the external casing C. The optimum separation distance P can be defined from the rightmost side R1 of the antenna layer 20 along the X-axis direction to the rightmost side R3 of the external casing C along the X-axis direction. Moreover, the rightmost side R1 of the antenna layer 20 along the X-axis direction can be substantially flushed with the rightmost side R2 of the substrate body 10 along the X-axis direction, and the topmost side T1 of the antenna layer 20 along the Y-axis direction can be substantially flushed with the topmost side T2 of the substrate body 10 along the Y-axis direction.

### Fourth Embodiment

Referring to FIGS. 1 and 5, where the fourth embodiment of the instance disclosure provides an antenna structure Z using an optimum separation distance P for reducing the SAR value. Comparing FIG. 5 with FIG. 4, the difference between the fourth embodiment and the third embodiment is that: the antenna structure Z of the second embodiment can be disposed on one corner area A4 of the external casing C. Moreover, the rightmost side R1 of the antenna layer 20 along the X-axis direction can be substantially flushed with the rightmost side R2 of the substrate body 10 along the X-axis direction, and the bottommost side B1 of the antenna layer 20 along the Y-axis direction can be substantially flushed with the bottommost side B2 of the substrate body 10 along the Y-axis direction. Of course, the optimum separation distance P also can be defined from the rightmost side R1 of the antenna layer 20 along the X-axis direction to the rightmost side R3 of the external casing C along the X-axis direction.

### Fifth Embodiment

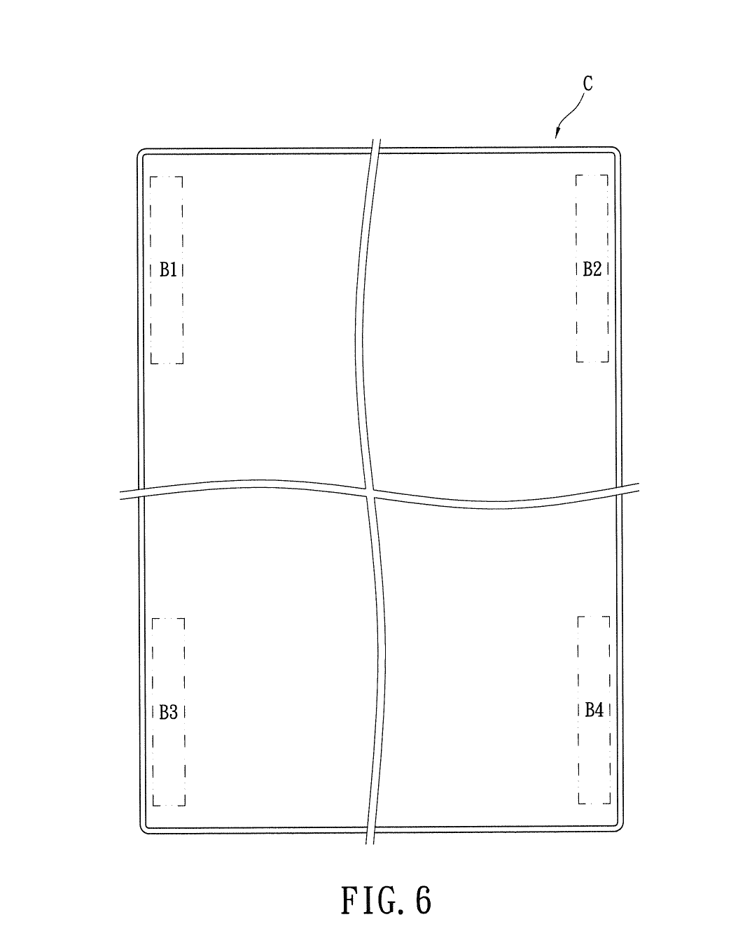

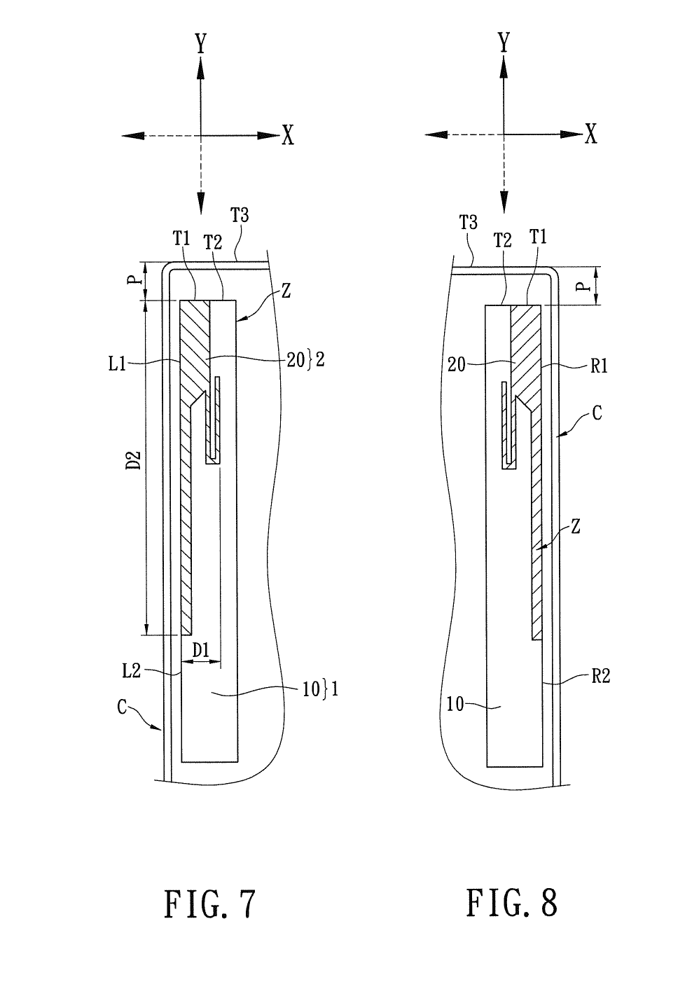

Referring to FIGS. 6 and 7, where the fifth embodiment of the instance disclosure provides an antenna structure Z disposed inside an external casing C (such as the casing of any electronic device) according to an optimum separation distance P for reducing the SAR value, and the antenna structure Z comprises a substrate unit 1 and an antenna unit 2. For example, the external casing C has a plurality of corner areas (B1, B2, B3 and B4 shown as the four phantom-line areas in FIG. 6) disposed in the external casing C and adjacent to the external surface of the external casing C, and the antenna structure Z can be disposed on one of the corner areas (B1, B2, B3 and B4) of the external casing C. For example, the antenna structure Z is disposed on the corner area B1 of the external casing C.

Referring to FIG. 7, the substrate unit 1 includes at least one substrate body 10. For example, the substrate body 10 may be a microwave substrate. However, the microwave substrate is merely an example and is not meant to limit the instant disclosure. Moreover, the antenna unit 2 includes at least one antenna layer 20 disposed on the substrate body 10, and the antenna layer 20 has at least one signal feeding point (no label in drawings) and at least one grounding point (no label in drawings). For example, the antenna layer 20 may be a PIFA (Plane Inverted-F Antenna). However, the PIFA is merely an example and is not meant to limit the instant disclosure.

Referring FIG. 7, the antenna layer 20 can be extended along an X-axis direction (the positive or the negative X-axis direction of the XY axis coordinate as shown in FIG. 7) to form an X-axis distance D1 and be extended along a Y-axis direction (the positive or the negative Y-axis direction of the XY axis coordinate as shown in FIG. 7) to form a Y-axis distance D2. The X-axis direction is vertical to the Y-axis direction, and the X-axis distance D1 of the antenna layer 20 is smaller than the Y-axis distance D2 of the antenna layer 20. In addition, the optimum separation distance P can be defined from one end of the antenna layer 20 to the external surface of the external casing C along the Y-axis direction, and the optimum separation distance P may be substantially between 5 mm and 20 mm. For example, when the optimum separation distance P is substantially between 5 mm and 20 mm from one end of the antenna layer 20 to the external surface of the external casing C along the Y-axis direction as shown in FIG. 7, and the test site for testing the SAR value of the antenna structure Z as shown in FIG. 7 is close to the leftmost side of the external casing C along the X-axis direction and the leftmost side L1 of the antenna layer 20 along the X-axis direction, the instant disclosure can obtain the SAR value less than 1.6 mW/g in high or low frequency operation according to the test site for testing the SAR value.

For example, referring to FIG. 7, the optimum separation distance P can be defined from the topmost side T1 of the antenna layer 20 along the Y-axis direction to the topmost side T3 of the external casing C along the Y-axis direction. In addition, the leftmost side L1 of the antenna layer 20 along the X-axis direction can be substantially flushed with the leftmost side L2 of the substrate body 10 along the X-axis direction, and the topmost side T1 of the antenna layer 20 along the Y-axis direction can be substantially flushed with the topmost side T2 of the substrate body 10 along the Y-axis direction.

### Sixth Embodiment

Referring to FIGS. 6 and 8, where the sixth embodiment of the instance disclosure provides an antenna structure Z using an optimum separation distance P for reducing the SAR value. Comparing FIG. 8 with FIG. 7, the difference between the sixth embodiment and the fifth embodiment is that: the antenna structure Z of the sixth embodiment can be disposed on one corner area B2 of the external casing C. Moreover, the rightmost side R1 of the antenna layer 20 along the X-axis direction can be substantially flushed with the rightmost side R2 of the substrate body 10 along the X-axis direction, and the topmost side T1 of the antenna layer 20 along the Y-axis direction can be substantially flushed with the topmost side T2 of the substrate body 10 along the Y-axis direction. Of course, the optimum separation distance P also can be defined from the topmost side T1 of the antenna layer 20 along the Y-axis direction to the topmost side T3 of the external casing C along the Y-axis direction.

### Seventh Embodiment

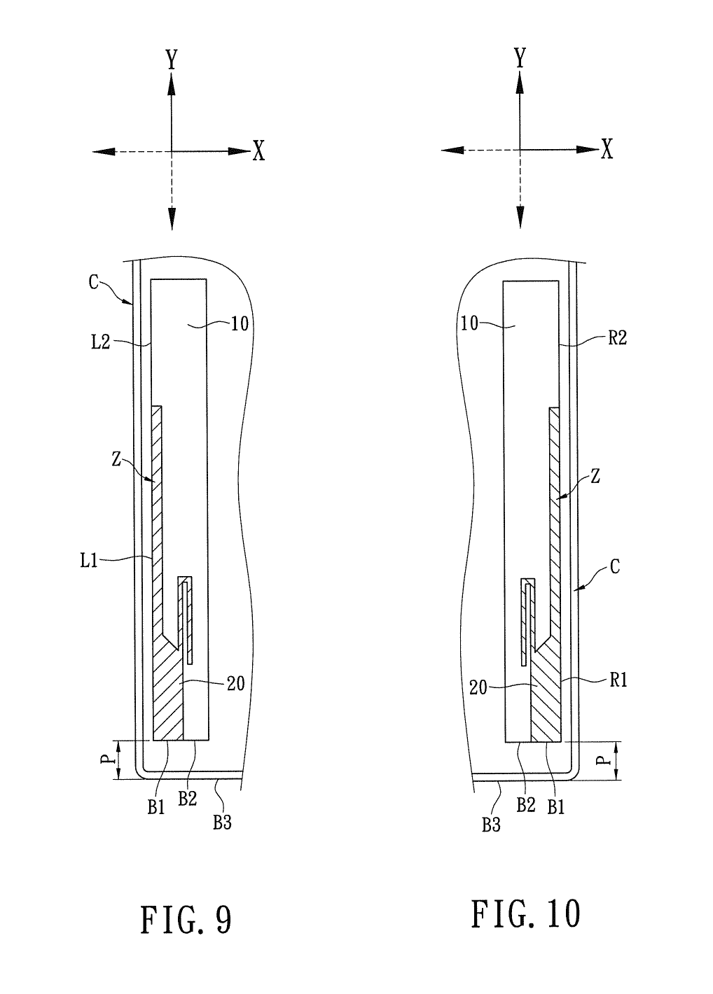

Referring to FIGS. 6 and 9, where the seventh embodiment of the instance disclosure provides an antenna structure Z using an optimum separation distance P for reducing the SAR value. Comparing FIG. 9 with FIG. 7, the difference between the seventh embodiment and the fifth embodiment is that: the antenna structure Z of the seventh embodiment can be disposed on one corner area B3 of the external casing C. The optimum separation distance P can be defined from the bottommost side B1 of the antenna layer 20 along the Y-axis direction to the bottommost side B3 of the external casing C along the Y-axis direction. Moreover, the leftmost side L1 of the antenna layer 20 along the X-axis direction can be substantially flushed with the leftmost side L2 of the substrate body 10 along the X-axis direction, and the bottommost side B1 of the antenna layer 20 along the Y-axis direction can be substantially flushed with the bottommost side B2 of the substrate body 10 along the Y-axis direction.

### Eighth Embodiment

Referring to FIGS. 6 and 10, where the eighth embodiment of the instance disclosure provides an antenna structure Z using an optimum separation distance P for reducing the SAR value. Comparing FIG. 10 with FIG. 9, the difference between the eighth embodiment and the seventh embodiment is that: the antenna structure Z of the second embodiment can be disposed on one corner area B4 of the external casing C. Moreover, the rightmost side R1 of the antenna layer 20 along the X-axis direction can be substantially flushed with the rightmost side R2 of the substrate body 10 along the X-axis direction, and the bottommost side B1 of the antenna layer 20 along the Y-axis direction can be substantially flushed with the bottommost side B2 of the substrate body 10 along the Y-axis direction. Of course, the optimum separation distance P also can be defined from the bottommost side B1 of the antenna layer 20 along the Y-axis direction to the bottommost side B3 of the external casing C along the Y-axis direction.

### Ninth Embodiment

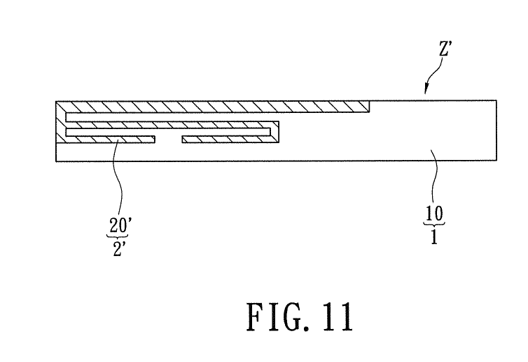

Referring to FIG. 11, where the ninth embodiment of the instance disclosure provides another antenna structure Z′ comprising a substrate unit 1 and an antenna unit 2′. The substrate unit 1 includes at least one substrate body 10. The antenna unit 2′ includes another antenna layer 20′ disposed on the substrate body 10. For example, the antenna layer 20′ may be a loop antenna. However, the loop antenna is merely an example and is not meant to limit the instant disclosure.

In conclusion, the optimum separation distance defined from one end of the at least one antenna layer to the external surface of the external casing along the X-axis direction is substantially between 5 mm and 20 mm, and the optimum separation distance defined from one end of the at least one antenna layer to the external surface of the external casing along the Y-axis direction is substantially between 5 mm and 20 mm, thus the instant disclosure can obtain the SAR value less than 1.6 mW/g in high or low frequency operation according to the test site close to the external casing for testing the SAR value of the antenna structure.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An antenna structure disposed inside an external casing according to an optimum separation distance for reducing the SAR value, comprising:
a substrate unit including at least one substrate body; and
an antenna unit including at least one antenna layer disposed on the at least one substrate body, wherein the at least one antenna layer is extended along an X-axis direction to form an X-axis distance and is extended along a Y-axis direction to form a Y-axis distance, the X-axis direction is vertical to the Y-axis direction, and the X-axis distance of the at least one antenna layer is larger than the Y-axis distance of the at least one antenna layer;
wherein the optimum separation distance is defined from one end of the at least one antenna layer to the external surface of the external casing along the X-axis direction, and the optimum separation distance is substantially between 5 mm and 20 mm.

2. The antenna structure of claim 1, wherein the external casing has a plurality of corner areas disposed therein and adjacent to the external surface thereof, and the antenna structure is disposed on one of the corner areas of the external casing.

3. The antenna structure of claim 1, wherein the optimum separation distance is defined from the leftmost side of the at least one antenna layer along the X-axis direction to the leftmost side of the external casing along the X-axis direction.

4. The antenna structure of claim 3, wherein the leftmost side of the at least one antenna layer along the X-axis direction is flushed with the leftmost side of the at least one substrate body along the X-axis direction, and the topmost side of the at least one antenna layer along the Y-axis direction is flushed with the topmost side of the at least one substrate body along the Y-axis direction.

5. The antenna structure of claim 3, wherein the leftmost side of the at least one antenna layer along the X-axis direction is flushed with the leftmost side of the at least one substrate body along the X-axis direction, and the bottommost side of the at least one antenna layer along the Y-axis direction is flushed with the bottommost side of the at least one substrate body along the Y-axis direction.

6. The antenna structure of claim 1, wherein the optimum separation distance is defined from the rightmost side of the at least one antenna layer along the X-axis direction to the rightmost side of the external casing along the X-axis direction.

7. The antenna structure of claim 6, wherein the rightmost side of the at least one antenna layer along the X-axis direction is flushed with the rightmost side of the at least one substrate body along the X-axis direction, and the topmost side of the at least one antenna layer along the Y-axis direction is flushed with the topmost side of the at least one substrate body along the Y-axis direction.

8. The antenna structure of claim 6, wherein the rightmost side of the at least one antenna layer along the X-axis direction is flushed with the rightmost side of the at least one substrate body along the X-axis direction, and the bottommost side of the at least one antenna layer along the Y-axis direction is flushed with the bottommost side of the at least one substrate body along the Y-axis direction.

9. An antenna structure disposed inside an external casing according to an optimum separation distance for reducing the SAR value, comprising:
a substrate unit including at least one substrate body; and
an antenna unit including at least one antenna layer disposed on the at least one substrate body, wherein the at least one antenna layer is extended along an X-axis direction to form an X-axis distance and is extended along a Y-axis direction to form a Y-axis distance, the X-axis direction is vertical to the Y-axis direction, and the X-axis distance of the at least one antenna layer is smaller than the Y-axis distance of the at least one antenna layer;
wherein the optimum separation distance is defined from one end of the at least one antenna layer to the external surface of the external casing along the Y-axis direction, and the optimum separation distance is substantially between 5 mm and 20 mm.

10. The antenna structure of claim 9, wherein the external casing has a plurality of corner areas disposed therein and adjacent to the external surface thereof, and the antenna structure is disposed on one of the corner areas of the external casing.

11. The antenna structure of claim 9, wherein the optimum separation distance is defined from the topmost side of the at least one antenna layer along the Y-axis direction to the topmost side of the external casing along the Y-axis direction.

12. The antenna structure of claim 11, wherein the leftmost side of the at least one antenna layer along the X-axis direction is flushed with the leftmost side of the at least one substrate body along the X-axis direction, and the topmost side of the at least one antenna layer along the Y-axis direction is flushed with the topmost side of the at least one substrate body along the Y-axis direction.

13. The antenna structure of claim 11, wherein the rightmost side of the at least one antenna layer along the X-axis direction is flushed with the rightmost side of the at least one substrate body along the X-axis direction, and the topmost side of the at least one antenna layer along the Y-axis direction is flushed with the topmost side of the at least one substrate body along the Y-axis direction.

14. The antenna structure of claim 9, wherein the optimum separation distance is defined from the bottommost side of the at least one antenna layer along the Y-axis direction to the bottommost side of the external casing along the Y-axis direction.

15. The antenna structure of claim 14, wherein the leftmost side of the at least one antenna layer along the X-axis direction is flushed with the leftmost side of the at least one substrate body along the X-axis direction, and the bottommost side of the at least one antenna layer along the Y-axis direction is flushed with the bottommost side of the at least one substrate body along the Y-axis direction.

16. The antenna structure of claim 14, wherein the rightmost side of the at least one antenna layer along the X-axis direction is flushed with the rightmost side of the at least one substrate body along the X-axis direction, and the bottommost side of the at least one antenna layer along the Y-axis direction is flushed with the bottommost side of the at least one substrate body along the Y-axis direction.
